(19) United States
(12) Patent Application Publication
(10) Pub. No.: US 2019/0130039 A1
(43) Pub. Date: May 2, 2019

(54) QUERY SERVER AND METHOD FOR PERFORMING QUERY RECOMMENDATIONS AND GROUP CREATION

(71) Applicants: Zheng Fang, Chicago, IL (US); Randy L. Ekl, Downers Grove, IL (US); Eric Johnson, Chicago, IL (US)

(72) Inventors: Zheng Fang, Chicago, IL (US); Randy L. Ekl, Downers Grove, IL (US); Eric Johnson, Chicago, IL (US)

(21) Appl. No.: 15/799,050

(22) Filed: Oct. 31, 2017

(51) Int. Cl. G06F 17/30

(52) U.S. Cl. CPC G06F 17/30867; G06Q 50/265; G06F 17/30976

(57) ABSTRACT

A method and query server are provided that provide historical query recommendations and group creation based on previous queries. Digital query requests are received from a plurality of electronic devices at a query server. The digital query requests each include a search string. The query server digitally stores the digital query requests in a digital storage medium. The query server determines a relevancy factor between query requests, the relevancy factor relates to the similarity between the two search strings.

### BACKGROUND OF THE INVENTION

Computer and smart phone users perform queries on a frequent basis. These queries are often typed in to the device, but alternate means of entering the search query exist, such as by using voice-to-text processing.

In current practice, each user performs queries that are only associated with that user. There are times when previous searches for each user are stored, and when that particular user begins to type the same request, the search engine can automatically finish the search request if it matches a previous request by that same user.

Currently there is no ability to connect searches from different users. Further, there is no way to interconnect searches that may be related. Therefore, a need exists for a way to correlate search requests among different users. In addition, a need exists for a method to connect users who make similar and possibly related search requests.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a portion of a communication system in accordance with an exemplary embodiment of the present invention.

FIG. 2 depicts a flow chart in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

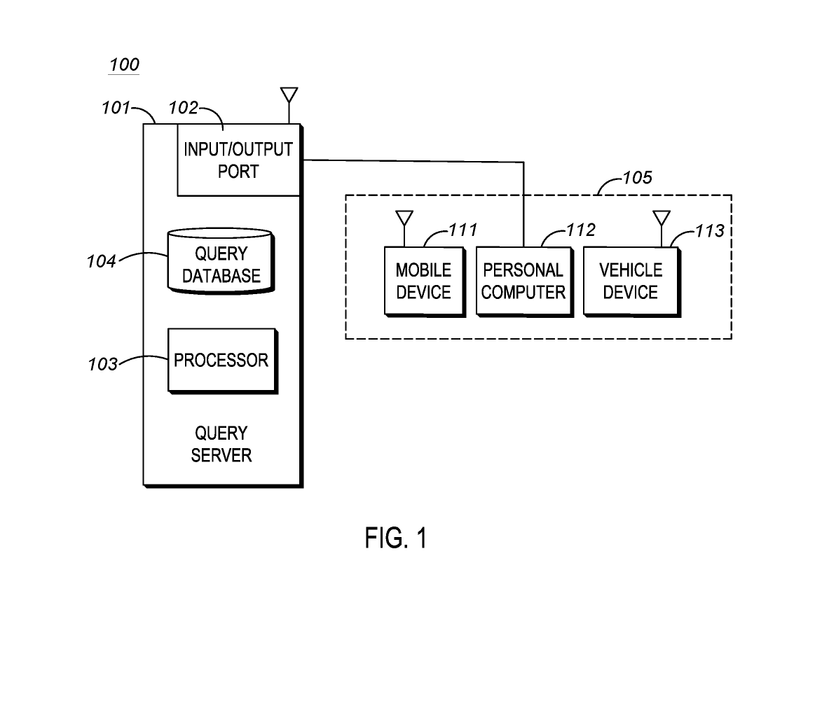

FIG. 1 depicts a system diagram of a portion of a communication system 100 in accordance with an exemplary embodiment of the present invention. Communication system 100 preferably comprises query server 101 and a plurality of electronic devices 105.

Query server 101 preferably includes input/output port 102, processor 103, and query database 104. Query server 101 can be a standalone element or can be included in another element within communication system 100.

Input/output port 102 is a port that allows data to be sent and received to electronic devices, such as mobile device 111, personal computer 112, and vehicle device 113. Input/output port 102 can be wireless or wired and use a variety of communication protocols.

Processor 103 is preferably a microprocessor that is a multipurpose, clock driven, register based, digital-integrated circuit which accepts binary data as input, processes it according to instructions stored in its memory, and provides results as output. Microprocessors contain both combinational logic and sequential digital logic.

Query database 104 is a database that serves as a repository which stores history of all queries from users and groups. In an exemplary embodiment, each query record includes the query content, time of the query, location of the device making the query, as well as context such as the role of the user making the query, the task list, group membership, weather and other environmental variables, specific incident assignment at the time of query, and incident type at the time of query, such as “robbery” or “fire”.

Electronic devices 105 can send and receive data and voice communications to query server 101. In the exemplary embodiment depicted in FIG. 1, electronic devices 105 comprises mobile device 111, personal computer 112, and vehicle device 113. It should be understood that a typical communication system would include hundreds and even thousands of electronic devices, but only three are depicted in FIG. 1 for clarity. It should also be understood that each user can have one or more of each type of device. For example, a public safety officer may have two mobile devices, one vehicular device, and two personal computers, all at the same time.

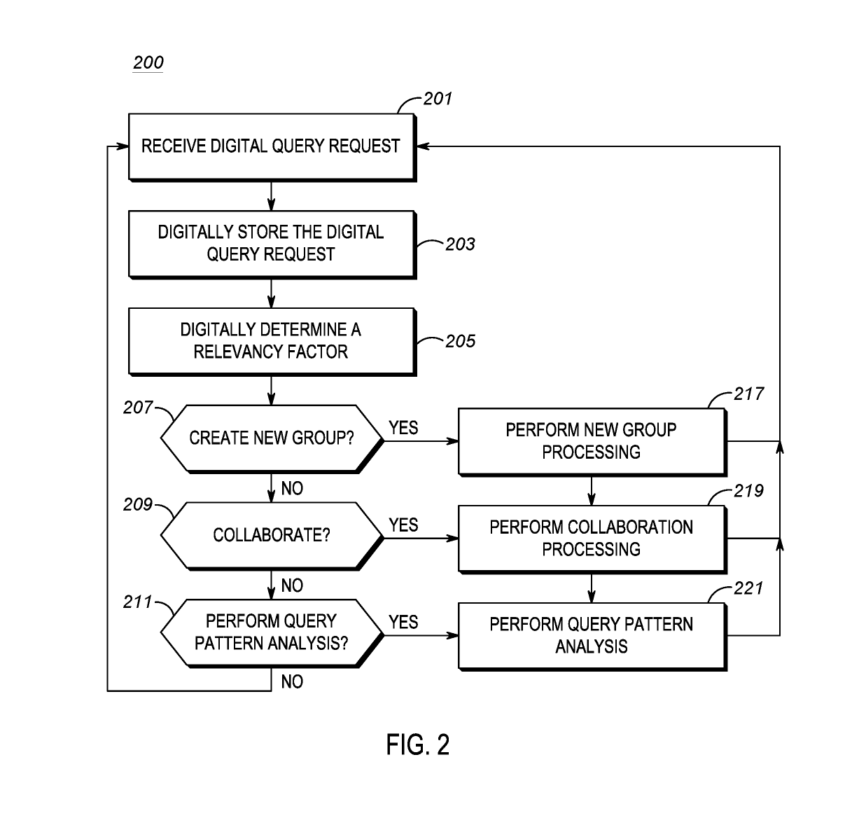

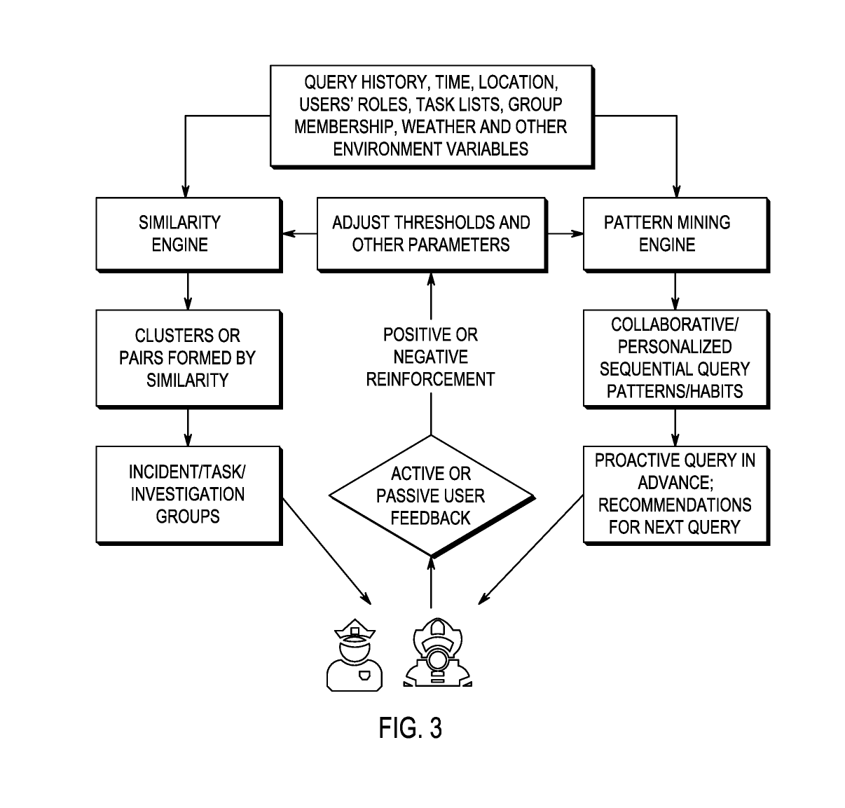

FIG. 2 depicts a flow chart 200 in accordance with an exemplary embodiment of the present invention.

Query server 101 receives (201) a digital query request. The digital query request preferably is received from an electronic device, such as mobile device 111, personal computer 112, or vehicle device 113. In accordance with an exemplary embodiment, the digital query request includes multiple fields in addition to the search string. These fields may include, for example, fields for a query history, time, location, context, users' roles, task lists, group membership, weather and other environment variables, specific incident assignment at the time of query, and incident type at the time of query, such as “robbery” or “fire”. The query request may also include a phonetic string, voice fingerprint information, images, video, or other media types. For example, a public safety officer may perform an image search or face scan to search a person database. In a second exemplary embodiment, a public safety officer may send a handwriting sample to match other evidentiary documents that include handwriting. In accordance with an exemplary embodiment, query server 101 will go through flowchart 200 several times and receive multiple digital query requests from a plurality of electronic devices 105.

Query server 101 stores (203) the digital query request, preferably in a digital storage medium such as query database 104. Query database 104 stores the digital query request and preferably indexes the stored record to make later searching easier and more effective.

Query server 101 digitally determines (205) a relevancy factor, preferably in processor 103. In accordance with an exemplary embodiment, processor 103 performs a linked query analysis to determine a relevancy factor between the current digital query request and other digital query requests. The linked query analysis is a process whereby processor 103 preferably analyzes and determines the similarity between the query histories of all users and groups, as well as the information related to the current user who is searching, to calculate a relevancy factor. The relevancy factor preferably relates to the similarity between the first search string and the second search string. In a further exemplary embodiment, query server 101 digitally determines a relevancy factor only when the difference between a first search time and a second search time is less than a predetermined time threshold.

In accordance with an exemplary embodiment, the relevancy factor is determined in the following manner. A list of features, such as location, role, and group membership, is considered for relevancy between two users. For each feature, the similarity score is preferably measured in that particular dimension. For example, for the query history, the similarity between the query history between two users, such as the percentage of identical queries submitted within a given time period, such as within a week or within a day we look at, is reviewed. The relevancy factor can range from 0.0 (totally different) to 1.0 (identical).

In like manner, the similarity score can be measured between the roles of two users. For example, two investigators preferably have similarity value of 1.0, while a paramedic and a field officer have a lower similarity score, such as 0.3. A similar analysis can be performed on group membership, task lists, and several other variables.

It should be understood that similarity scores and relevancy factors are shown in decimal values, but the level of precision can be varied based upon the application. In an exemplary embodiment, time, location, weather and other environmental variables are context information that can be used to enhance the similarity scores.

In accordance with an exemplary embodiment, the final relevancy factor is the weighted average among all similarity scores generated from the list of features. The weight can be predetermined, but can alternately be variable and chosen either by the system or by the customer. Other mathematical functions can be used in place of weighted average.

Query server 101 determines (207) whether a new group should be created. In this exemplary embodiment, query server 101 identifies clusters of users or groups based on the query history during a same time window along with user information. These clusters can be potential new groups based on the compactness of the cluster. Compactness is preferably determined via analysis of all of the factors associated with the queries, users, group membership, and the like, not just physical compactness based on location. Standard data science algorithms such as k-Nearest Neighbor or similar can be utilized for this purpose. In accordance with an exemplary embodiment, query server 101 recommends to users that they join the newly created group, and the users can decide whether they wish to join the newly created and suggested group.

If query server 101 determines that it should create a new group at step 207, query server 101 performs (217) New Group Processing. In accordance with an exemplary embodiment, query server 101 creates a new group comprising the first user and the second user when the relevancy factor exceeds a predetermined threshold. It should be understood that more than two users can be included in the newly created group.

In accordance with an exemplary embodiment, the relevancy factor can have several dynamic thresholds. For example, if the relevancy factor between two users is larger than 0.8, an exemplary embodiment creates a new group for them, else if the score is larger than 0.6, then recommend collaborations between them. Note that the similarity score is dynamically evolving when new queries are made, and the groups and collaborations would also be dynamic changing based on the relevancy factor. A user can also manually keep or dismiss a group or collaboration recommended from query server 101, and query server 101 learns from the feedback, preferably based on supervised machine learning algorithms, and automatically adjust the thresholds.

If it is determined at step 207 that a new group should not be created at this time, query server 101 determines (209) whether the current searcher should collaborate with any other user or users. In an exemplary embodiment, query server 101 determines that the current searcher should collaborate when the relevancy factor exceeds a predetermined threshold.

If query server 101 determines that the current searcher should collaborate with another user, query server 101 performs (219) Collaboration Processing. For example, in the scenario when two users are currently in different groups and investigating two different incidents. From their query history, query engine 101 determines a high similarity between their search requests and suggests collaboration and information sharing between the two users as they are potentially dealing with relevant incidents.

If it is determined at step 209 that the current searcher should not collaborate with other users at this time, query server 101 determines (211) if it should perform Query Pattern Analysis.

If query server 101 determines that it should perform query pattern analysis, query server 101 performs (221) Query Pattern Analysis. In an exemplary embodiment, query server 101 receives a first digital query request and a second digital query request from a first user. The second digital query request is determined to be related to the first digital query request. When a third digital query request that is substantially similar to the first digital query request is received from a second user, query server 101 sends the results of the second digital query request to the second user in response to the third digital query request.

In this manner, query server 101 learns frequent query patterns from query history, both collaboratively and personally; and can proactively offer results of relevant queries prior to them being asked, to relevant personnel. In a first exemplary embodiment, this occurs by providing a search string to a second searcher when a first search string has been entered by the second searcher. In a further exemplary embodiment, this occurs by automatically and without input by the second searcher performing a second search that is related to the first search and conveying the search results to the second searcher without input from the second searcher.

As an example, query server 101 extracts frequently used search strings that are coupled to other search strings from query database 104. In this example, query server 101 determines that for public safety users, a search for a license plate occurs thirty percent of the time after a search for a specific driver's license identification number. In a first exemplary embodiment, query server 101 provides the second search string in the query entry window of the second searcher when the second searcher performs a search on the first search string. In a second exemplary embodiment, query server 101 performs the search on the second search string and automatically sends the search results to the second searcher upon completion of the first query, without input from the second user. By utilizing query pattern analysis, query engine 101 can predict a user's next query with certain confidence and run the query in advance, cache and share the query results among the group of personnel who tends to make the same query.

If it is determined at step 211 that query pattern analysis should not be performed at this time, processing returns to step 201 and query server 101 waits to receive the next digital query request.

Query pattern analysis and similarity analysis are preferably performed continuously in the background, so the similarity scores are always up to date, and a user can receive the recommended query and notification and results from query server 101 that captures latest patterns.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving a plurality of digital query requests from a plurality of electronic devices including a first user and a second user, the plurality of digital query requests including a first digital query request from the first user and a second digital query request from the second user, the first digital query request comprising a first search string and the second digital query request comprising a second search string;
digitally storing the plurality of digital query requests in a digital storage medium; and
digitally determining a relevancy factor between the first digital query request and the second digital query request, wherein the relevancy factor relates to the similarity between the first search string and the second search string.

2. The method of claim 1, the method further comprising the step of creating a new group comprising the first user and the second user when the relevancy factor exceeds a predetermined threshold.

3. The method of claim 2, wherein the predetermined threshold is dynamic.

4. The method of claim 1, wherein the first digital query request includes a first search time, and wherein the second digital query request includes a second search time, and wherein the step of digitally determining a relevancy factor comprises digitally determining a relevancy factor only when the difference between the first search time and the second search time is less than a predetermined time threshold.

5. The method of claim 4, wherein the predetermined time threshold is dynamic.

6. The method of claim 1, the method further comprising the step of connecting the first user and the second user when the relevancy factor exceeds a predetermined threshold.

7. The method of claim 6, wherein the step of connecting comprises suggesting collaboration and information sharing between the two users as they are potentially dealing with relevant incidents.

8. The method of claim 1, wherein each of the plurality of digital query requests comprises a group field.

9. The method of claim 1, wherein each of the plurality of digital query requests comprises a time field.

10. The method of claim 1, wherein each of the plurality of digital query requests comprises a location field.

11. The method of claim 1, wherein each of the plurality of digital query requests comprises a context field.

12. The method of claim 11, wherein the context field comprises a user role field.

13. The method of claim 11, wherein the context field comprises a task list field.

14. The method of claim 11, wherein the context field comprises an incident field.

15. The method of claim 11, wherein the context field comprises an incident type field.

16. The method of claim 11, wherein the context field comprises a group membership field.

17. The method of claim 1, wherein each of the plurality of digital query requests comprises an environmental field.

18. A method comprising:
receiving a first digital query request from a first user;
receiving a second digital query request from the first user, the second digital query request being related to the first digital query request;
receiving a third digital query request from a second user, the third digital query request being substantially similar to the first digital query request; and
sending the results of the second digital query request to the second user in response to the third digital query request.

19. A query server comprising a processor configured to:
receive a plurality of digital query requests from a plurality of electronic devices including a first user and a second user, the plurality of digital query requests including a first digital query request from the first user and a second digital query request from the second user, the first digital query request comprising a first search string and the second digital query request comprising a second search string;
digitally store the plurality of digital query requests in a digital storage medium; and
digitally determine a relevancy factor between the first digital query request and the second digital query request, wherein the relevancy factor relates to the similarity between the first search string and the second search string.

20. The query server of claim 19, wherein the processor is further configured to create a new group comprising the first user and the second user when the relevancy factor exceeds a predetermined threshold.
